(19) United States
(12) Patent Application Publication
(10) Pub. No.: US 2009/0065489 A1
(43) Pub. Date: Mar. 12, 2009

(54) ARC WELDING

(76) Inventor: John Duffy, East Sussex (GB)

Correspondence Address: The BOC Group, Inc., 575 MOUNTAIN AVENUE, MURRAY HILL, NJ, 07974-2082, US

(21) Appl. No.: 12/065,916

(22) PCT Filed: Sep. 5, 2006
(86) PCT No.: PCT/GB2006/050272

§ 371 Date: Sep. 4, 2008

(30) Foreign Application Priority Data
Sep. 9, 2005 (GB) 0518458.5

(51) Int. Cl. B23K 9/00

(52) U.S. Cl. 219/137 R; 219/136

(57) ABSTRACT

In the control of a semi-automatic or automatic electric arc welding operation, the concentration in the atmosphere remote from the arc of a plurality of fume components is monitored. Control signals are fed or transmitted to at least one process control means which is programmed to adjust a plurality of operational parameters in response to the control signals.

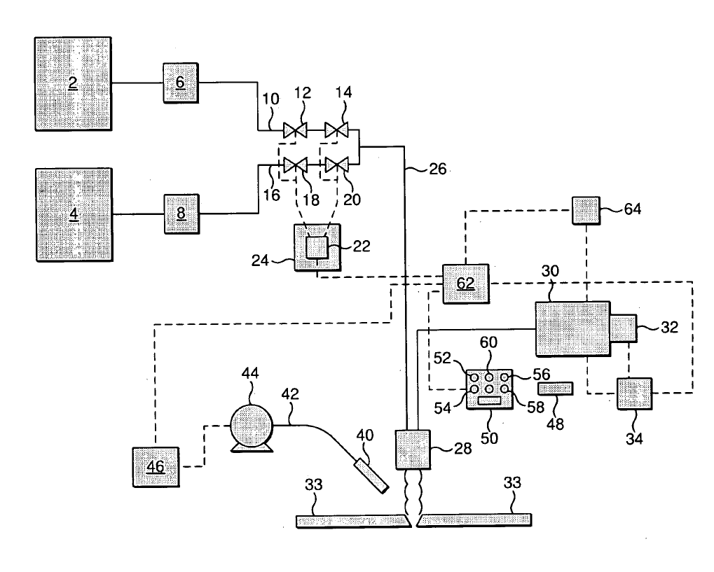

### CROSS REFERENCE TO RELATED APPLICATIONS

This application claims priority from International Patent Application Serial No. PCT/GB2006/050272, filed 5 Sep. 2006 (published as WO 2007/029033 A1, with publication date 15 Mar. 2007), which claims priority from British Patent 0518458.5, filed 9 Sep. 2005.

### BACKGROUND OF THE INVENTION

This invention relates to a method of an apparatus for controlling a semi-automatic or automatic electric arc welding operation.

Electric arc welding is a well known industrial operation which makes use of an electric arc to generate the heat necessary to melt an electrode or filler material which provides the weld metal. In semi-automatic or automatic electric arc welding the electrode or filler material takes the form of a coil of wire which is continuously fed to the arc. Gas Metal Arc Welding (GMAW), commonly called Metal Inert Gas (MIG) welding, is a type of welding which utilises a welding gun or torch through which a continuous wire electrode and an inert shielding gas are fed. The wire typically has a diameter in the range of 0.7 to 1.6 mm diameter. When welding steel, to guard against nitrogen and oxygen from the atmosphere contaminating the weld, the inert shielding gas, which is fed around the arc, usually comprises a mixture of argon and carbon dioxide, although the shielding gas may additionally include helium. Typically a constant voltage welding power supply is used to provide the necessary current to the welding electrode, with an arc being struck between the tip of the electrode and the work. An alternative semi-automatic or automatic electric arc welding process is Flux-Cored Arc Welding (FCAW) which uses a hollow wire filled with a welding flux having a composition that typically eliminates the need for an externally-supplied shielding gas. Another form of semi-automatic or automatic arc welding process is Gas Tungsten Arc welding (GTAW), commonly known as Tungsten Inert Gas (TIG) welding. In this process a non-consumable tungsten electrode is used and the electric arc is struck between this electrode and the work. A welding wire, known as a filler, may be continuously fed to the welding arc. A constant current welding power supply is typically employed to enable the necessary arc to be struck. A shielding gas such as argon is employed which is ionised in the arc to form a plasma.

Within each particular welding process there are a number of process variables including welding current, arc voltage, shielding gas flow rate, wire feed speed and the rate of extraction of fume form the vicinity of the welding process. There is also the ability to influence the welding process by choosing a particular composition of shielding gas or a particular wave form for the electric power supply. It is known to control the welding process by monitoring what is happening in the welding arc. GB-A-1 512 850 discloses a method of and apparatus for monitoring the atmosphere within an electric arc. Atmosphere is withdrawn from the vicinity of the arc by a suction pump and is supplied to a nitrogen oxide measuring device. In the latter, arc atmosphere is reacted under reduced pressure with ozone. The apparatus includes a generator to produce the necessary ozone. A photoelectric device detects, by way of an optical filter and a multiplier, infrared radiation having an intensity proportional to the mass flow rate of nitric oxide. The photoelectric device provides an electric output signal which is amplified and fed to a differential amplifier for comparison with a reference signal representative of a desired concentration of nitrogen oxide in the atmosphere. The output from the differential amplifier may be used to shut down the welding process in the event of the monitored concentration of nitrogen oxide being too high and to control the flow of shielding gas.

Electric arc welding is known to generate a fume which contains gaseous and particulate components. Unlimited exposure to arc welding fume is now considered to be potentially hazardous to the health of the welder. Appropriate regulatory bodies in some jurisdictions specify guidelines for exposure to materials found in welding fume.

As stated above, GB-A-1 512 850 provides a method of monitoring nitrogen oxide formation and adjusting the shielding gas flow. There is a need, however, for improved methods of and apparatus for controlling a semi-automatic or automatic arc welding process.

### BRIEF SUMMARY OF THE INVENTION

In its broadest aspect, the present invention provides a method and apparatus for controlling a fume-generating industrial operation, comprising continuously or repeatedly monitoring at a location (for example, where there is an atmosphere which is inhaled by an operative) remote from where the fume is generated the concentrations in the atmosphere of a plurality of fume components, generating control signals from the monitoring, and feeding or transmitting the control signals to at least one process control means which is programmed to adjust a plurality of operational parameters in response to the control signals.

The method and apparatus according to the invention may be used to control any one of a number of different industrial operations including laser cutting, laser welding, and flame cutting. It is particularly suited, however, to the control of semi-automatic or automatic arc welding processes.

According to the present invention there is provided a method of controlling a semi-automatic or automatic electric arc welding operation, comprising the steps of repeatedly or continuously monitoring at a location remote from the arc the concentrations in the atmosphere of a plurality of fume components, generating control signals from the monitoring, and feeding or transmitting the control signals to at least one process control means which is programmed to adjust a plurality of operational parameters in response to the control signals.

The invention also provides apparatus for controlling a semi-automatic or automatic electric arc welding operation, comprising a plurality of sensors positioned at a location remote from the arc for repeatedly or continuously monitoring the concentrations in the atmosphere of a plurality of fume components, means associated with the sensors for generating control signals, at least one programmable process control means for adjusting a plurality of operational parameters associated with the electric arc welding operation, and means for feeding or transmitting the control signals to the said process control means.

The location remote from the arc is preferably one close to and at the level of the welder's face. In this way, the welding process can be controlled so as to minimise the hazards presented to the welder. Thus, at least one of the sensors may be incorporated into a helmet or respirator worn by the welder.

Preferably, the concentrations of fume components that are monitored are those of ozone and particulate solids. If desired, other gaseous fume components may be monitored in addition or alternatively to ozone. These components include oxides of nitrogen, sulphur dioxide, and halogens. In addition, it is desirable to monitor the incidence of ultra violet radiation and the incidence of infrared radiation.

The operational parameters that are adjusted may be selected from shielding gas flow rate, shielding gas composition, wire feed speed, welding current, arc voltage, and the rate of extraction of welding fume from the vicinity of the arc.

Adjustments to the chosen operating parameters may be made by comparison with reference values that are typically programmed into the said process controller. The apparatus according to the invention preferably includes at least one data logger able to log sensed values of chosen fume components and means for comparing the sensed values with reference values.

In an alternative method and apparatus according to the invention, mathematical formulae may be empirically derived correlating a plurality of the operational parameters to a plurality of values that are functions of concentrations of different components of the fume and the said process control means is programmed with algorithms based on such formulae, thereby enabling the process control means to select preferred values of the operating parameters according to the sensed concentrations of the chosen components of the fume.

The apparatus according to the invention preferably includes at least one data conversion, data transmission and/or data memory device associated with each concentration sensor.

Each concentration sensor is preferably operatively associated with electrical or electronic means for providing instantaneous (“real time”) measurement of a desired parameter and/or for providing cumulative (integrated) measurements of that parameter.

### BRIEF DESCRIPTION OF THE DRAWING

The method and apparatus according to the invention will now be described by way of example with reference to the accompanying drawing which is a schematic diagram of an arc welding apparatus according to the invention.

### DETAILED DESCRIPTION OF THE INVENTION

Referring to the drawing, a welding apparatus of a conventional kind includes a source 2 of a first component of a gaseous shielding mixture and a source 4 of a second component of the mixture. As shown, in the drawing, both the sources 2 and 4 take the form of vacuum-insulated vessels containing the desired shielding gas components in liquid state. For example, the vessel 2 may contain liquid argon and the vessel 4 liquid carbon dioxide. The storage vessel 2 is associated with a vaporiser 6 and the storage vessel 4 with a vaporiser 8. The vaporiser 6 is preferably of a kind that causes the liquid argon to flow through a heat exchange coil which is exposed to a flow of ambient air. The vaporiser 8 is preferably an electrically heated vaporiser. Resulting vaporised argon flows from the vaporiser 6 to a pipeline 10 in which are disposed an isolation valve 12 and a flow control valve 14. Similarly, vaporised carbon dioxide flows from the vaporiser 8 along a pipeline 16 in which are disposed an isolation valve 18 and a flow control valve 20. The flow control valves 14 and 20 are automatically operated by means of a controller 22 which is located in a panel 24. The valve controller is adapted to transmit signals to the valves to change their positions so as to adjust in a controlled manner the flow rate of each gas. Because the pipelines 10 and 16 meet downstream of the control valves 14 and 20 in a common pipeline 26 (typically in the form of a length of hose) the controller 22 may be employed to adjust in a controlled manner either the flow rate of the resulting gas mixture or its composition, or both.

The common pipeline 26 extends to an arc welding gun 28. The arc welding gun 28 may be of a conventional kind. The features of the welding gun 28 depend on whether the chosen arc welding process is a GMAW or a GTAW one. The welding gun 28 is operatively associated with a welding machine 30 which is also of a conventional kind and is able to provide a welding voltage and welding current to the gun 28. In addition, the welding machine 30 includes or is separate from a wire feeder 32 which is operable to feed a welding wire, which in a GMAW process constitutes the electrode, to the welding gun 28. The welding machine 30 and wire feeder 32 are operatively associated with a further programmable controller 34.

The welding gun 28 typically has a trigger (not shown) which may be actuated by a welder to initiate a welding procedure. The trigger may send a signal to the controllers 22 and 34 to start the flow of shielding gas, to actuate the wire feeder 32 and to apply the welding voltage and current. An arc is struck between the welding electrode (not shown) and the workpieces 33 to be welded. As a result, the tip of the welding wire melts and the molten metal is transferred to a pool of molten weld metal which on solidification forms the weld.

A hollow probe 40 forming part of a fume extraction means is located near the arc and communicates via a length of flexible tubing 42 with a pump 44 or other means operable to withdraw gas from the vicinity of the arc. The pump is typically of a rotary kind. The speed of rotation is controlled by a further programmable controller 46. The fume extraction system may additionally include filters (not shown) for the removal of solid particles and a UV lamp (not shown) for the destruction of ozone.

The apparatus shown in the drawing also includes a number of sensors arranged so as to feed information about the welding process to the controllers 22, 34 and 46. The sensors include a device 48 for measuring the number and/or mass per unit volume of solid particles in the welding fume at a location from which the welder is likely to inhale air. The device 48 typically takes the form of an instrument for measuring the forward scattering of electromagnetic radiation by solid particles. The source of the electromagnetic radiation may be a laser. Such instruments are commercially available. If desired, the device 48 may be located at welder's head level and/or may be incorporated into the fume extraction system similar to that comprising the probe 40, the tubing 42 and the pump 44.

Other sensors are incorporated into the welder's helmet which is indicated by the reference numeral 50. Such sensors comprise an ozone sensor 52, an ultraviolet radiation sensor 54, an infrared radiation (ir) sensor 56 and a noise sensor 58. In addition, the concentration of hazardous gases other than ozone (e.g. oxides of nitrogen) may be monitored by means of one or more sensors 60 also incorporated into the welder's helmet 50. The sensors 52, 54, 56, 58 and 60 may all be of a kind which can be plugged into suitable sockets (not shown) provided in the helmet 50.

Various different control arrangements are possible. For example, selected sensors may transmit signals to each individual controller. The controllers may each be programmed with reference data and control signals generated by comparing the incoming signals with the reference data. In an alternative arrangement, each of the sensors 48, 52, 54, 56, 58 and 60 is adapted to send signals to a central data processing unit 62 which is operatively associated with each of the programmable controllers 22, 28 and 46. The sensors may be provided with associated electrical or electronic circuits (not shown) which enable the signals to be transmitted continuously or at chosen time intervals. Further circuits may be provided to calculate cumulative values of each sensed parameter. The central data processing unit 62 may also be operatively associated with one or more local or remote data display units (not shown) and may transmit information thereto for display and/or for further processing. In addition, the apparatus according to the invention typically includes a data logger 64 which is associated with the welding machine 30 and the wire feeder 32 and is able to send to the central data processing unit 62 information about the wire feed speed, the welding voltage and the welding current. The central data processing unit 62 is typically programmed with algorithms which express the concentration of particular components of the fume as a function of different welding parameters and therefore enable the controllers 22, 28 and 46 to adjust the welding current, welding voltage, wire feed speed, shielding gas composition, shielding gas flow rate and fume extraction flow rate so as to result in a safe atmospheric environment for the welder.

Various different authorities make recommendations as to the minimum level of exposure to certain hazardous substances in the welding fume. The apparatus according to the invention may be operated so as to ensure that the welding process is conducted in a manner compliant with these recommendations. The central processing unit 62 is typically also able to log the history of exposure of any particular welder. Accordingly, cumulative levels of exposure to any hazard may be monitored. Thus, the central processing unit 62 may include software which requires each individual welder to enter his or her identity before the welding apparatus can be actuated. The processing unit 62 may also be programmed so as to prevent actuation of the welding apparatus in the event of any particular individual welder having a history of exposure to a hazard that is close to exceeding recommended levels over a given period of time. Further, the central processing unit 62 may be able to shut down the apparatus in the event of a hazardous condition being created.

There may be considerable flexibility in the way in which the apparatus according to the invention is operated. The relationship between the operating parameters of the process and the level of particular components of the fume is a complex one. For example, increasing the arc welding voltage may help to reduce the formation of particulate contamination but may result in an increased formation of ozone. Therefore, it will be normal to adjust a plurality of parameters at the same time. Similarly, increasing the amount of carbon dioxide in the shielding gas may increase the formation of particulate fume but reduce the amount of ozone formed. Various control algorithms may be developed by plotting the concentration of each selected component of the welding fume against each relevant operational parameter and correlating the results.

The method and apparatus according to the invention is particularly advantageous because for the first time it provides a control of the welding process which is dependent not on what occurs in the welding arc but rather the exposure of the welder to particular components of the welding fume. Accordingly, a control that is truly sensitive to the conditions experienced by the welder is made possible.

1. A method of controlling a semi-automatic or automatic electric arc welding operation, comprising the steps of repeatedly or continuously monitoring at a location remote from the arc the concentration in the atmosphere of a plurality of fume components, generating control signals from the monitoring, and feeding or transmitting the control signals to at least one process control means which is programmed to adjust a plurality of operational parameters in response to the control signals.

2. The method as claimed in claim 1, in which the location remote from the arc is one close to and at the level of the welder's face.

3. The method as claimed in claim 1, in which the concentration of particulate solids is monitored.

4. The method as claimed in claim 1, in which the concentration of ozone is monitored.

5. The method as claimed in claim 1, in which the incidence of ultraviolet radiation is monitored at a chosen location.

6. The method as claimed in claim 1, in which the incidence of infrared radiation is monitored at a chosen location.

7. The method as claimed in claim 1, further comprising adjusting the flow rate of shielding gas.

8. The method as claimed in claim 1, further comprising adjusting the shielding gas composition.

9. The method as claimed in claim 1, further comprising adjusting wire feed speed.

10. The method as claimed in claim 1, further comprising adjusting welding current.

11. The method as claimed in claim 1, further comprising adjusting arc voltage.

12. The method as claimed in claim 1, further comprising adjusting the rate of extraction of welding fume from the vicinity of the arc.

13. The method as claimed in claim 1, in which adjustments to the chosen operating parameters are made by comparison with reference values that are programmed into the said process control means.

14. The method according to claim 1, in which mathematical formulae are empirically derived correlating a plurality of the operational parameters to a plurality of values that are functions of concentrations of different components of the fume, and the said process control means is programmed with algorithms based on such formulae, thereby enabling the process control means to select preferred values of the operating parameters according to the sensed concentrations of the chosen components of the fume.

15. An apparatus for controlling a semi-automatic or automatic electric arc welding operation, comprising a plurality of sensors positioned at a location remote from the arc for repeatedly or continuously monitoring the concentrations in the atmosphere of a plurality of fume components, means associated with the sensors for generating control signals and at least one programmable process control means for adjusting a plurality of operational parameters associated with the electric arc welding operation, and means for feeding or transmitting the control signals to the said process control means.

16. The apparatus as claimed in claim 15, in which the chosen location is one close to and at the level of the welder's face.

17. The apparatus as claimed in claim 15, in which the plurality of sensors includes a sensor for monitoring the concentration of particulate fume.

18. The apparatus as claimed in claim 15, in which the plurality of sensors includes a sensor for monitoring the concentration of ozone.

19. The apparatus as claimed in claim 15, further comprising means for adjusting the shielding gas flow rate.

20. The apparatus as claimed in claim 15, further comprising means for adjusting shielding gas composition.

21. The apparatus as claimed in claim 15, further comprising means for adjusting wire feed speed.

22. The apparatus as claimed in claim 15, further comprising means for adjusting welding current.

23. The apparatus as claimed in claim 15, further comprising means for adjusting arc voltage.

24. The apparatus as claimed in claim 15, further comprising means for adjusting the rate of extraction of welding fume from the vicinity of the arc.

25. The apparatus as claimed in claim 15, further comprising at least one data logger able to log sensed values of chosen fume components and means for comparing the sensed values with reference values.

26. The apparatus according to claim 15, in which each concentration sensor has associated therewith at least one device selected from the group consisting of data conversion, data transmission and data memory.

27. The apparatus as claimed in claim 15, in which each concentration sensor is operatively associated with electrical or electronic means for providing instantaneous measurement of a desired parameter and/or for providing cumulative measurements of that parameter.
